(19) United States
(12) Patent Application Publication
(10) Pub. No.: US 2020/0045733 A1
(43) Pub. Date: Feb. 6, 2020

(54) Uplink Scheduling For NR-U

(71) Applicant: Nokia Technologies Oy, Espoo (FI)

(72) Inventors: Esa T. Tiirola, Kempele (FI); Kari J. Hooli, Oulu (FI); Timo E. Lunttila, Espoo (FI); Klaus Hugl, Wien (AT); Karol Schober, Helsinki (FI)

(73) Assignee: Nokia Technologies Oy

(21) Appl. No.: 16/054,325

(22) Filed: Aug. 3, 2018

(51) Int. Cl. H04W 74/08; H04L 1/18; H04W 16/14; H04W 72/04; H04W 72/14

(52) U.S. Cl. CPC H04W 74/0808; H04L 1/1812; H04W 72/14; H04W 72/0413; H04W 16/14

(57) ABSTRACT

A method is provided including: transmitting an uplink grant to a user equipment indicating a plurality of scheduled transmission time intervals within a continuous wideband resource allocation over a plurality of sub-channels; attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; attempting to receive a further transmission from the user equipment in each of the transmission time intervals following the first transmission time intervals, where each further transmission corresponds to a further hybrid automatic repeat request process; and determining a hybrid automatic repeat request process identifier for each successfully received first transmission and for each successfully received further transmission.

### TECHNICAL FIELD

This invention relates generally to wireless communications and, more specifically, relates to uplink scheduling.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, at the beginning of the detailed description section.

Unlicensed frequency bands are portions of the radio frequency spectrum that do not require a license for use and may therefore be used by any device to transmit or receive radiofrequency signals. Licensed wireless networks may utilize unlicensed frequency bands to provide additional bandwidth for communications between base stations and user equipments, for example. The operation of such communications may be based on different standards, such as Licensed Assisted Access (LAA) and MulteFire for example. LAA provides licensed-assisted access to unlicensed spectrum while coexisting with other technologies and fulfilling regulatory requirements, whereas MulteFire relates to stand-alone unlicensed band operation.

### BRIEF SUMMARY

This section is intended to include examples and is not intended to be limiting.

In an example of an embodiment, a method is disclosed that includes: receiving, from a network node, an uplink grant indicating a plurality of scheduled transmission time intervals within a continuous wideband resource allocation over a plurality of sub-channels; for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel; in response to determining that one or more of the sub-channels are available for transmission, transmitting the corresponding transmissions over the respective available sub-channels in each of the first transmission time intervals; for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and transmitting each of the further transmissions over all the available sub-channels in the corresponding remaining transmission time interval.

An additional example of an embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An example of an apparatus includes one or more processors and one or more memories including computer program code. The one or more memories and the computer program code are configured to, with the one or more processors, cause the apparatus to perform at least the following: receiving, from a network node, an uplink grant indicating a plurality of scheduled transmission time intervals within a continuous wideband resource allocation over a plurality of sub-channels; for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel; in response to determining that one or more of the sub-channels are available for transmission, transmitting the corresponding transmissions over the respective available sub-channels in each of the first transmission time intervals; for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and transmitting each of the further transmissions over all the available sub-channels in the corresponding remaining transmission time interval.

In another example of an embodiment, an apparatus comprises means for receiving, from a network node, an uplink grant indicating a plurality of scheduled transmission time intervals within a continuous wideband resource allocation over a plurality of sub-channels; for each respective sub-channel in one or more first transmission time intervals of the plurality of transmission time intervals: means for determining an identifier for a hybrid automatic repeat request process corresponding to the respective sub-channel, and means for preparing a transmission for the hybrid automatic repeat request process corresponding to the respective sub-channel; in response to determining that one or more of the sub-channels are available for transmission, means for transmitting the corresponding transmissions over the respective available sub-channels in each of the first transmission time intervals; for each of the remaining transmission time intervals: means for determining a further identifier for a further hybrid automatic repeat request process corresponding to the respective remaining transmission time interval, and means for preparing a further transmission for the hybrid automatic repeat request process corresponding to the respective remaining transmission time interval; and means for transmitting each of the further transmissions over all the available sub-channels in the corresponding remaining transmission time interval.

In an example of an embodiment, a method is disclosed that includes transmitting, from a network node to a user equipment, an uplink grant to a user equipment indicating a plurality of scheduled transmission time intervals within a continuous wideband resource allocation over a plurality of sub-channels; attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; attempting to receive a further transmission from the user equipment in each of the transmission time intervals following the first transmission time intervals, where each further transmission corresponds to a further hybrid automatic repeat request process; and determining, by the network node, a hybrid automatic repeat request process identifier for each successfully received first transmission and for each successfully received further transmission.

An additional example of an embodiment includes a computer program, comprising code for performing the method of the previous paragraph, when the computer program is run on a processor. The computer program according to this paragraph, wherein the computer program is a computer program product comprising a computer-readable medium bearing computer program code embodied therein for use with a computer.

An example of an apparatus includes one or more processors and one or more memories including computer program code. The one or more memories and the computer program code are configured to, with the one or more processors, cause the apparatus to perform at least the following: transmitting, from a network node to a user equipment, an uplink grant to a user equipment indicating a plurality of scheduled transmission time intervals within a continuous wideband resource allocation over a plurality of sub-channels; attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; attempting to receive a further transmission from the user equipment in each of the transmission time intervals following the first transmission time intervals, where each further transmission corresponds to a further hybrid automatic repeat request process; and determining, by the network node, a hybrid automatic repeat request process identifier for each successfully received first transmission and for each successfully received further transmission.

In another example of an embodiment, an apparatus comprises means for transmitting, from a network node to a user equipment, an uplink grant to a user equipment indicating a plurality of scheduled transmission time intervals within a continuous wideband resource allocation over a plurality of sub-channels; means for attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; means for attempting to receive a further transmission from the user equipment in each of the transmission time intervals following the first transmission time intervals, where each further transmission corresponds to a further hybrid automatic repeat request process; and means for determining, by the network node, a hybrid automatic repeat request process identifier for each successfully received first transmission and for each successfully received further transmission.

### BRIEF DESCRIPTION OF THE DRAWINGS

In the attached Drawing Figures:

FIG. 1 is a block diagram of one possible and non-limiting exemplary system in which the exemplary embodiments may be practiced;

FIG. 2 shows an example of eLAA multi-subframe scheduling where LBT succeeds for all carriers/sub-channels;

FIG. 3 shows an example where LBT fails due to some sub-channels/carriers being occupied;

FIG. 4 shows an example of HARQ operation in an NR system that applies a wideband operation with bandwidth parts;

FIG. 5 shows an example where data symbols are punctured on sub-channels that are not available for transmission;

FIG. 6 shows an example embodiment of the subject matter described herein;

FIGS. 7A-7C show further example embodiments of the subject matter described herein;

FIG. 8 shows another example embodiment of the subject matter described herein;

FIG. 9 shows a signaling diagram in accordance with exemplary embodiments;

FIG. 10 shows another example embodiment of the subject matter described herein; and

FIGS. 11 and 12 are logic flow diagrams for uplink scheduling for NR-U, and illustrate the operation of exemplary methods, a result of execution of computer program instructions embodied on a computer readable memory, functions performed by logic implemented in hardware, and/or interconnected means for performing functions in accordance with exemplary embodiments.

### DETAILED DESCRIPTION OF THE DRAWINGS

The following abbreviations that may be found in the specification and/or the drawing figures are defined as follows:

3GPP third generation partnership project

5G fifth generation

BW bandwidth

BWP bandwidth Part

COT channel occupancy time

DCI downlink control information

DL downlink

eLAA enhanced LAA

eNB (or eNodeB) evolved Node B (e.g., an LTE base station)

gNB 5G Node B, base station

HARQ hybrid automatic repeat request

I/F interface

iFFT inverse fast Fourier transform

LAA licensed assisted access

LBT listen-before-talk

LTE long term evolution

MCS modulation and coding scheme

MME mobility management entity

N/W or NW network

NCE network control element

NDI new data indicator

NR new radio

NR-U new radio unlicensed

PDCCH physical downlink control channel

PDSCH physical downlink shared channel

PRB physical resource block

PUSCH physical uplink shared channel

RB resource block

Rel release

RRH remote radio head

Rx receiver

SGW serving gateway

TB transport block

TBS transport block size

TS technical specification

Tx transmitter

UCI uplink control information

UE user equipment

UL uplink

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for uplink scheduling for NR-U. Additional description of these techniques is presented after a system into which the exemplary embodiments may be used is described.

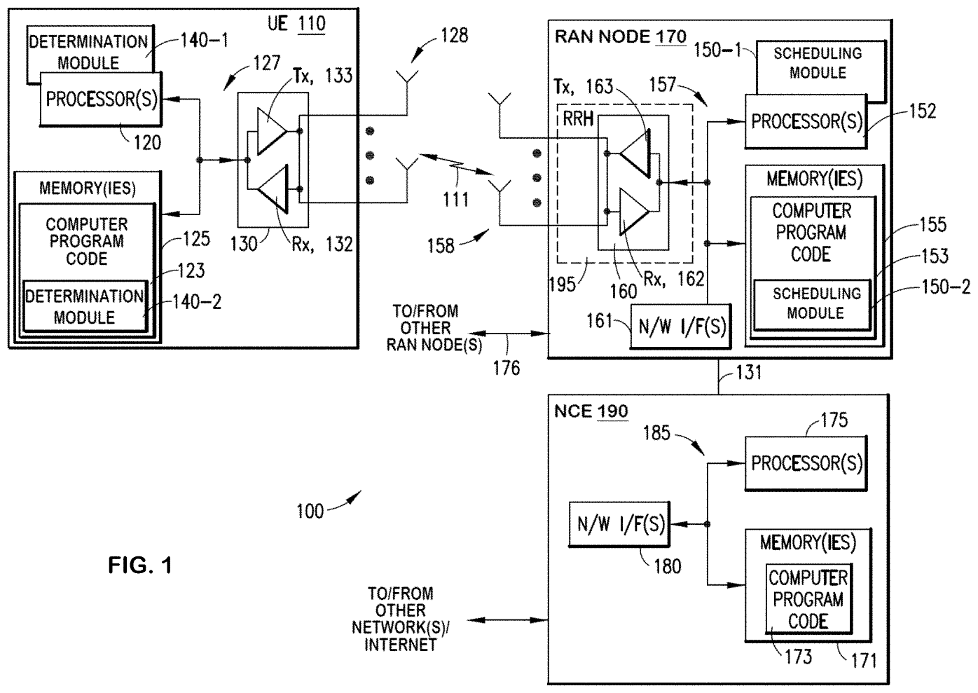

Turning to FIG. 1, this figure shows a block diagram of one possible and non-limiting exemplary system in which the exemplary embodiments may be practiced. In FIG. 1, a user equipment (UE) 110 is in wireless communication with a wireless network 100. A UE is a wireless, typically mobile device that can access a wireless network. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module, comprising one of or both parts 140-1 and/or 140-2, which may be implemented in a number of ways. The determination module may be implemented in hardware as determination module 140-1, such as being implemented as part of the one or more processors 120. The determination module 140-1 may be implemented also as an integrated circuit or through other hardware such as a programmable gate array. In another example, the determination module may be implemented as determination module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with radio access network (RAN) node 170 via a wireless link 111.

The RAN node 170 may be a base station that provides access by wireless devices such as the UE 110 to the wireless network 100. For example, the RAN node 170 may be a node (e.g. a base station) in a NR/5G network such as a gNB (a node that provides NR user plane and control protocol terminations towards the UE 110) or an ng-eNB (a node providing E-UTRA user plane and control plane protocol terminations towards the UE 110, and connected via an NG interface to the core network (i.e. 5G Core (5GC)). The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The RAN node 170 includes a scheduling module, comprising one of or both parts 150-1 and/or 150-2, which may be implemented in a number of ways. The scheduling module may be implemented in hardware as scheduling module 150-1, such as being implemented as part of the one or more processors 152. The scheduling module 150-1 may be implemented also as an integrated circuit or through other hardware such as a programmable gate array. In another example, the scheduling module may be implemented as scheduling module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. The one or more network interfaces 161 communicate over a network such as via the links 176 and 131. Two or more RAN nodes 170 communicate using, e.g., link 176. The link 176 may be wired or wireless or both and may implement, e.g., an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the RAN node 170 being physically in a different location from the RRH, and the one or more buses 157 could be implemented in part as fiber optic cable to connect the other elements of the RAN node 170 to the RRH 195.

It is noted that various RAN node functions may be virtualized functions instantiated on an appropriate platform, such as a cloud infrastructure. For example, the RAN node 170 may include a centralized unit (CU) and one or more distributed units (DUs) interconnected through an F1 logical interface. Together, a CU and underlying DUs may be considered as forming a logical base station. The CU may be considered a logical node that hosts some base station protocols, and may control, at least in part, the operations of the one or more DUs. The one or more DUs may host the remaining base station protocols. As an example, the CU may host the RRC, SDAP, and PDCP protocols, and the one or more DUs may host the RLC, MAC, and PHY layer protocols. A CU also be known with other names such as BBU/REC/RCC/C-RAN/V-RAN, and a DU may also be known with other names such as a RRH/RRU/RE/RU.

It is also noted that the description herein indicates that “cells” perform functions, but it should be clear that the RAN node that forms the cell will perform the functions. The cell makes up part of a RAN node. That is, there can be multiple cells per RAN node. For instance, there could be three cells for a single RAN node carrier frequency and associated bandwidth, each cell covering one-third of a 360 degree area so that the single RAN node's coverage area covers an approximate oval or circle. Furthermore, each cell can correspond to a single carrier and a RAN node may use multiple carriers. So if there are three 120 degree cells per carrier and two carriers, then the RAN node has a total of 6 cells.

The wireless network 100 may include one or more network control elements (NCE) 190, each of which includes functionalities for carrying out a set of network functions (NFs), and may provide connectivity with a further network, such as a telephone network and/or a data communications network (e.g., the Internet). The set of NFs may include, for example, an Access and Mobility Function (AMF) and a User Plane Function (UPF). The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations. The RAN node 170 is coupled via a link 131 to the NCE 190. The link 131 may be implemented as, e.g., an NG interface for 5G, or an S1 interface for LTE, or any other suitable interface for other standards. In case of LTE network, the NCE 190 may include a MME (Mobility Management Entity) and SGW (serving gateway) functionalities.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Having thus introduced one suitable but non-limiting technical context for the practice of the exemplary embodiments of this invention, the exemplary embodiments will now be described with greater specificity.

### Listen Before Talk (LBT) Operation on LTE LAA and MulteFire Uplink

In LTE LAA, two channel access procedures are defined for LBT, namely, Type 1 (a variant of Category 4 energy detection LBT procedure as described in TS36.889) and Type 2 (a variant of Category 2 energy detection LBT procedure):

In Type 1 LBT, UE generates a random number N uniformly distributed over a contention window (where the size of contention window depends on the channel access priority class of the traffic). Once UE has measured the channel to be vacant for N times, UE may occupy the channel with transmission. To align the transmission with LTE subframe boundary, UE may need to resort to self-deferral during the LBT procedure.

In Type 2 LBT, UE performs single channel measurement in time interval of 25 us before UL transmission. For PUSCH, this type of LBT may be performed when a base station shares its channel occupancy time (COT) with the UE.

It is attractive to support UL transmission with Type 2 LBT within gNB acquired COT also on NR-unlicensed, as it supports efficiently scheduled UL as well as UL FDMA. NR-U may support single and multiple DL to UL and UL to DL switching within a shared gNB COT acquired by gNB.

In MulteFire, UE may also skip LBT procedure for UL control signaling within eNB acquired COT if UL transmission starts within 16 us after the end of DL transmission.

### Wideband Operation on NR-U

There are several wide unlicensed bands and even a single gNB or a UE can occasionally access very wide bandwidths. Hence, wideband operation is one of the key building blocks for NR-U. Both carrier aggregation and bandwidth part (BWP) mechanisms are supported in licensed Rel-15 NR for wideband operations. It is expected that NR-U should use both of these mechanisms to achieve sufficiently versatile support for wideband.

Conventional carrier aggregation offers several benefits, such as frequency domain flexibility as aggregated carriers do not need to be adjacent but may be spaced widely apart. This offers diversity for channel access for example. Also, each carrier may employ its own LBT procedure thus providing agile channel access. Thus, it can be seen that carrier aggregation should be supported for NR unlicensed (in addition to facilitating the LAA operation with NR licensed carrier). Of course, carrier aggregation also has its price as multiple RF chains are required which in turn increases the price of UE transceivers. Additionally, carrier aggregation increases UE power consumption and has rather considerable latency in the component carrier activation/deactivation (to save UE power).

It is noted that a bandwidth part is contiguous set of common resource blocks (see 3GPP Section 4.4.4.3 of TS 38.211 for example) of a given numerology on a given carrier. A BWP may be determined by a starting position, a number of RBs and a numerology. It is also noted that configured BWPs of a serving cell can be overlapping or non-overlapping, whereas component carriers in LTE are only non-overlapping, and a BWP can also be smaller than BW of network carrier. Furthermore, in R15 NR, also BWPs configured in different serving cells can be physically overlapping.

In Rel-15 NR, the concept of serving cell adaptive BW was introduced by means of BWPs. In Rel-15 NR, a UE is instructed to operate on a specific part of gNB's BW, that is, on a BWP. Up to 4 BWPs can be configured separately for UL and DL per serving cell. Each BWP can have, for example, separately configured subcarrier spacing (SCS), cyclic prefix length, BW in terms of contiguous PRBs as well as location/start of the BW in the cell's total BW. Each BWP can further have, for example, separately configured K0, K1 and K2 values defining the time offsets from DL assignment reception to the beginning of PDSCH, from the end of PDSCH to HARQ-ACK transmission time, and from UL grant reception to the start of PUSCH transmission, respectively. In case of unpaired spectrum (i.e. TDD), UL and DL BWPs can be paired, in which case the center frequency of both BWPs is the same. One of the BWPs may be defined as a default BWP of narrow BW to, for example, facilitate UE battery saving.

In Rel-15 NR, a UE may have only one BWP active at a time. Active BWP can be indicated by a field in the DCI or by RRC signaling. BWP switching occurs after UE has received the signaling changing the active BWP, but switching time is yet to be determined. UE may also fall back to default BWP after a configured period of inactivity. To achieve the power saving effect, UE needs to adapt its RF BW.

The BWP mechanism provides an alternative wideband mechanism when accessing unlicensed spectrum on adjacent 20 MHz channels as it can provide savings in the UE cost with reduced number of RF chains. A single RF chain and FFT processing can be used to access wide bandwidth of e.g. 80 MHz or 160 MHz on 5 GHz or 6 GHz (potential) unlicensed bands. It also improves the trade-off between UE throughput and battery consumption via fast BWP switching. As the BWP switching time can be shorter than the component carrier (de)activation time (subject of current discussion in RAN4), a UE can be switched rather aggressively to a narrow BWP (and back to a wideband BWP) saving UE battery and compromising throughput less than the slower CC (de)activation. On the other hand, NR BWP switching time (hundreds of microseconds, e.g. 600 or 2000 us) has clearly a different order of magnitude than a single CCA (e.g. 9 us) in LBT procedure. This poses constraints on how BWP operation and LBT can interact.

Channel contention mechanism is one of the key components for efficient wideband operation and the channel contention mechanism for wideband operations should be considered for NR. It is noted that both Wi-Fi and LTE LAA LBT operate on 20 MHz channels and some of the regulatory rules, e.g. ETSI's standard, require LBT operation on 20 MHz grid at 5 GHz band. Hence, to meet regulatory requirements and to ensure fair coexistence with other systems, also NR-U should support 20 MHz grid for LBT operation at least for the 5 GHz unlicensed band. Of course, also wider LBT BWs should be supported such as for higher frequency unlicensed bands or for potential new unlicensed bands like the 6 GHz band for example.

### Multi-Slot/Subframe Scheduling

Multi-subframe scheduling is part of LTE Rel-14 eLAA specification. More specifically, multi-subframe PUSCH scheduling is beneficial for a UE, because after the UE accesses channel, it shall exploit the COT to the maximum. In eLAA multi-channel transmission operates with conventional carrier aggregation, i.e. multi-subframe scheduling operates per carrier (that equals 20 MHz sub-channel). Multi-subframe scheduling can minimize the PDCCH overhead in cases where multiple consecutive UL subframes are scheduled for the same UE.

Recently, it was agreed that scheduling multiple TTIs for PUSCH using a single UL grant should be supported in NR-U. In NR, BWP-based wide-band operation was introduced as an alternative to conventional carrier aggregation. There are several challenges in designing multi-slot scheduling for wider-bandwidth operation, such as:
Uncertainty in UE's LBT time and frequency domain. More specifically, a gNB does not know when a UE will be able to access channel, and thus the gNB does not know how many of the 20 MHz sub-channels UE will be able access.
Transmission preparation time at the UE. UE needs a certain amount of time (e.g. X microseconds) to prepare a transmission. Preparation may include e.g.: getting data from higher layers; TBS determination; channel coding and modulation; RE mapping; iFFT; digital filtering and/or RF retuning.
Number of HARQ processes required. When the BWP becomes large, such as 200 MHz, using one HARQ process/ID per 20 MHz requires large number of HARQ processes per slot.

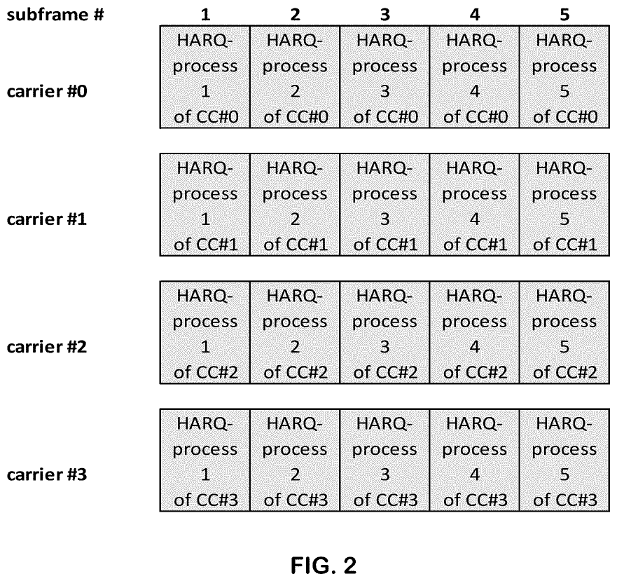

In eLAA, carrier bandwidth is always equal to the (sub-) channel bandwidth (e.g. 20 MHz). Multi-subframe scheduling is applied per carrier, namely, each carrier (and sub-channel) is scheduled with a dedicated multi-subframe UL grant. Moreover, each carrier has its own HARQ processes and transport blocks (although the numbering may be the same for different carriers). FIG. 2 shows an example of eLAA multi-subframe scheduling where LBT succeeds for all carriers/sub-channels. In the example shown in FIG. 2, there are 5 subframes×4 carriers=20 HARQ processes (and TBs) scheduled.

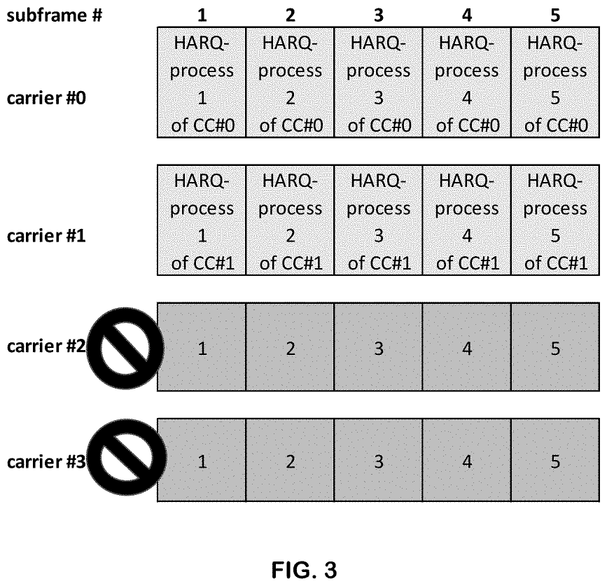

FIG. 3 shows an example where LBT fails as some of sub-channels/carriers are occupied and cannot be accessed. The TBs corresponding to the occupied sub-channels/carriers that are not transmitted. In the example shown in FIG. 3, carriers #2 and #3 are not accessible.

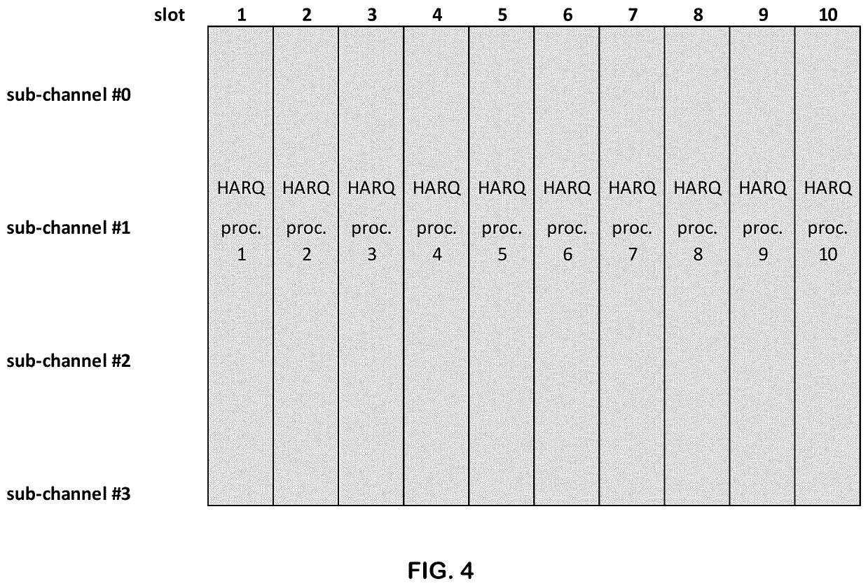

FIG. 4 shows an example of HARQ operation in an NR R15 system that applies a wideband operation with bandwidth parts. In this example, there is one HARQ process and transport block per BWP. In this situation, if some of the sub-channels cannot be used for transmission, such as if one or more of the sub-channels are not free (i.e. LBT fails), then a first option is to not transmit on any of the sub-channels (i.e. no transmission at all). This option is not optimal as a UE not transmitting on any of the sub-channels leads to inefficient UL resource usage as well as increased latency and reduced UL throughput for a UE. In particular, for this option there is UL traffic transmission only in case all the scheduled 20 MHz would be available.

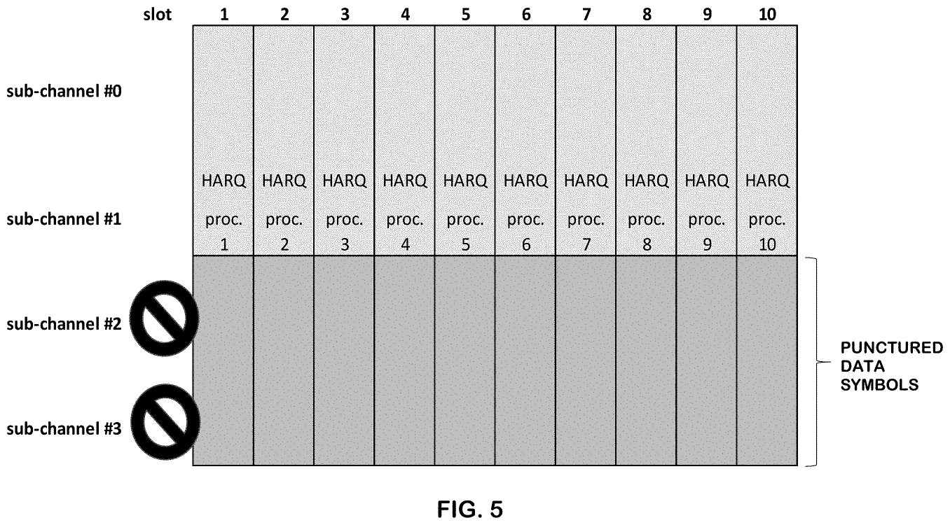

A second option is to puncture the data symbols (i.e. no transmission) on the sub-channels not available for transmission. FIG. 5 shows an example of this second option. In FIG. 5, sub-channels #2 and #3 are unavailable, and the data symbols corresponding to these sub-channels are punctured (i.e. not transmitted). This second option is also not optimal as puncturing data symbols leads to reduced coding rate and in the worst case would lead to puncturing a full NR-U code blocks and decoding failure, as NR in contrast to LTE does not apply interleaving between the different coded blocks of the PUSCH transmission. As a consequence, link adaptation would lose its meaning for wideband NR-U uplink transmission (as the effective coding rate would be given by the available sub-channels) and the puncturing may lead to high probability of not being able to receive at least some (highly punctured) PUSCH codeblocks. As in the case of transmission dropping, this second options leads to low UL throughput and an extensive need to schedule UL re-transmissions (which again may be affected by the puncturing due to WB operation and not all the channels being available).

A third option is to have separate HARQ-processes and transport blocks for each slot and each sub-channel similar as in case of carrier aggregation/eLAA shown in FIG. 2. However, this option would lead to a very large number of required HARQ processes when accessing wide BW, making HARQ operation (including feedback) cumbersome and impractical.

Various example embodiments enable multi-slot/subframe scheduling to operate on a NR BWP comprising one or more 20 MHz sub-channels. According to various example embodiments HARQ-process IDs and Transport block sizes for multi-slot and multi sub-channel transmissions may be defined such that the LBT success on different sub-channels is taken into account.

It is noted that the term ‘transmission time interval’ as used herein generally refers to a ‘slot’ or a ‘mini-slot’. A ‘slot’ denotes, e.g., time-domain resource allocations scheduled using Type A allocation, where DMRS symbol is on a fixed position of a slot and allocations range between 4-14 symbols. A ‘mini-slot’ denotes, e.g., time-domain resource allocations scheduled by Type B allocation, where DMRS symbol is the first symbol of the transmission and allocations range between 1-14 symbols, such as shown in TS38.214, Table 6.1.2.1-1 for example. The type (for example ‘Type A’ or ‘Type B’) of time-domain resource allocation is signaled dynamically to a UE in the scheduling DCI. It is also noted that a ‘transmission’ may correspond to one transport block or multiple transport blocks using typically the same resource elements (such as for a multi-codeword transmission for example).

According to an example embodiment, there are n first slots or mini-slots (at least in the 1st slot or mini slot), and there are up to X HARQ processes per slot/mini-slot, where X=number of unlicensed sub-channels scheduled (20 MHz each). TB(s) for each independent HARQ process may be prepared per 20 MHz sub-channel and the received frequency domain resource allocation is masked per 20 MHz sub-channel, to determine the number of RBs for transport block size (TBS) determination of the respective HARQ process on the sub-channel. The gaps (e.g. guard bands) between sub-channels can be either left empty or filled with some data. The number of n first slots (or mini-slots) in which there are sub-channel specific transport blocks may be at least one of: configured by the gNB via RRC signaling; depend on the UE's capability (e.g. processing times) and can be indicated by the UE to the gNB; and fixed in a wireless specification. In the later slots (or mini-slots), there may be just one HARQ process per slot (or mini-slot) that is common for all 20 MHz sub-channels. As a UE is aware of the available sub-channels ahead of time, the UE is able to take the available sub-channels into account to determine the correct TBS based on the available sub-channels (subject of LBT), the received frequency domain resource allocation, and the received MCS indication.

In an alternative implementation, the TBS in the multi-slot UL grant for the transport block size may be indicated based on the following options:
Option 1: A single sub-channel which applies directly to the transport blocks in first n slots. TBS for the later slots is upscaled, e.g. by multiplying by the number of sub-channels used for transmission; or
Option 2: A total number of scheduled sub-channels where TBSs for first n slots are downscaled, e.g. by dividing the indicated TBS by the number of scheduled sub-channels. The TBS for the later slots may then be calculated as: TBS=indicated_TBS*(number_of_accessed_sub-channels/number_of_scheduled_sub-channels).
Option 3: Overall wideband (WB) allocated resources over all sub-channels. In this case, the TBS for the first n slots is downscaled, e.g. by dividing the indicated TBS by scaling it with the relation of the number of RBs of a respective sub-channel and the total number of RBs of the WB allocation, e.g., TBS=indicated_TBS*(number_of_RBs_sub-channels/number_of_scheduled_RBs). The TBS for the later, WB slots is calculated by scaling the indicated TBS with the relation of the number of RBs of the available sub-channels and the total number of RBs of the WB allocation: TBS=indicated_TBS*(number_of_RBs accessed_sub-channels/number_of_scheduled_RBs)
   For each of options 1-3, further rounding after the TBS scaling may be applied such that the scaled TBS matches e.g. a predefined set of possible TBSs.

According to some example embodiments, further TBS down-scaling may be applied in case mini-slots are used in the beginning of the transmission burst. For example, MCS in the multi-slot UL grant may indicate modulation and coding rate for either: a single sub-channel or a total number of scheduled channels. Modulation and coding rate indicated for a single sub-channel may apply directly to first n slots. MCS for the later slots may be upscaled as MCS in the first n slots takes into account CQI of the weakest sub-band, while average CQI is considered in later slots. In case modulation and coding rate for a total number of scheduled channels is indicated, the modulation and coding rate may be applied to the later slots, and the MCS for the first slots may be downscaled by an offset (and rounded). The offset for MCS upscaling or downscaling can be signaled together with the MCS or pre-configured.

It is noted that a same MCS may be applied to all the slots. In this case, the TBS size for each slot and HARQ process may be determined independently resulting in different TB sizes for the first n slots/mini-slots with separate HARQ processes/IDs per sub-channel compared to the later slots with a single HARQ process/ID per slot/mini-slot.

As in the later transmission time intervals UE determines the TBS based on the available sub-channels, the received frequency domain resource allocation and the received MCS or TBS indication, the network node needs to determine or derive the correct TBS for successfully receiving the transmissions from the UE in the later transmission time intervals. For derivation of the correct TBS, the network node determines the sub-channels available for the UE and on which the UE performs transmission. The network node may determine the sub-channels used for transmission by the UE based on the successfully received transmissions on the first transmission time intervals, e.g., by detecting the presence of reference signals or, possibly, by detecting related control information contained on the transmissions on the first transmission time intervals.

Further example embodiments relate to determining a HARQ-process ID for each transport block. In one example embodiment, the HARQ-process ID for the 1^{st} transport block on the lowest (or, alternatively, the highest) indexed sub-channel is indicated to a UE in the multi-subframe UL grant. Next, the UE determines the HARQ-IDs for the other TBs scheduled on other sub-channels in the same slot. Finally, the UE determines the HARQ-process IDs for TBs in the later slots with a single HARQ process/ID per slot/mini-slot.

As an example, consider the case of M scheduled slots/mini-slots (slot index m=1 . . . M), where n defines the number of slots/mini-slots having independent HARQ processes for each sub-channel (as noted above), and having a resource allocation of X sub-channels (where the scheduled sub-channels are indexed as x=1 . . . X). UL grant may include a HARQ-ID which defines the start of the used HARQ processes (which may be denoted as HARQₛₜₐᵣₜ herein). In total, HARQₘₐₓ UL HARQ processes are to be supported. Assuming a mapping from the lowest to highest sub-channel, the HARQ-IDs may be mapped as follows:
For the first 1≤m≤n slots/mini-slots, the HARQ-IDs per sub-channel x are given by:

HARQ(m,x)=(HARQₛₜₐᵣₜ+(m−1)*X+x−1)mod HARQₘₐₓ
For the remaining n<m≤M slots/mini-slots, there is a single HARQ-ID per slot/mini-slot over all the available sub-channels which is given by:

HARQ(m)=(HARQₛₜₐᵣₜ+n*X+m−n−1)mod HARQₘₐₓ
where mod denotes modulo operation.

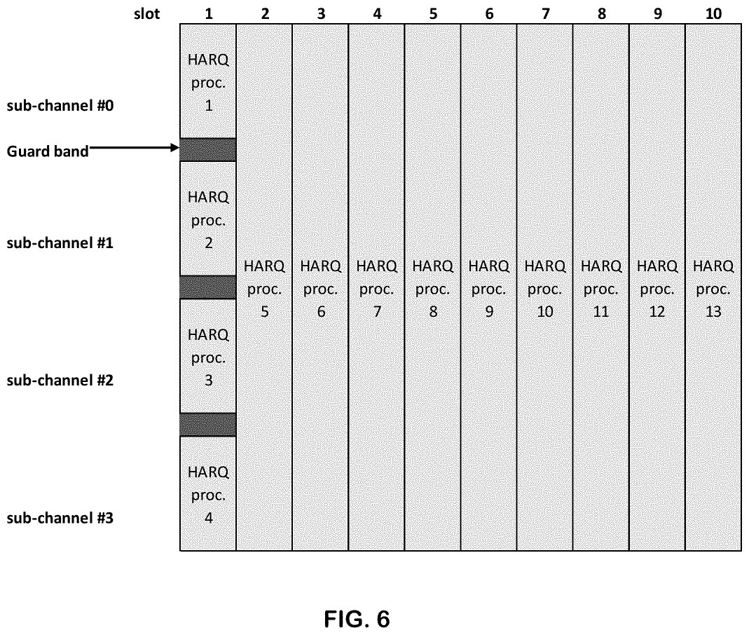

Referring now to FIG. 6, this figure shows an example of an embodiment having ten slots (labeled 1-10) and four sub-channels (labeled sub-channel #0-#3), where all the sub-channels are available for transmission. In this example, DCI indicates that HARQₛₜₐᵣₜ=1, and the HARQ-IDs are mapped as described above where X=4 sub-channels, n=1, and M=10. More specifically, 13 HARQ processes are supported where slot 1 supports four HARQ processes and the remaining slots each support a single HARQ process. For example, the HARQ-ID corresponding to HARQ(1, 2) (i.e. for slot 1, sub-channel 2) in this example is calculated by (1+(1−1)*4+2−1)mod 13=2. The HARQ-ID corresponding to HARQ(2) (i.e. slot 2) is calculated by (1+1*4+2−1−1)=5. For completeness it is noted that if HARQₛₜₐᵣₜ was equal to a different number, such as 5 for example, then the HARQ-ID for sub-channel #0 in slot 1 would be 5.

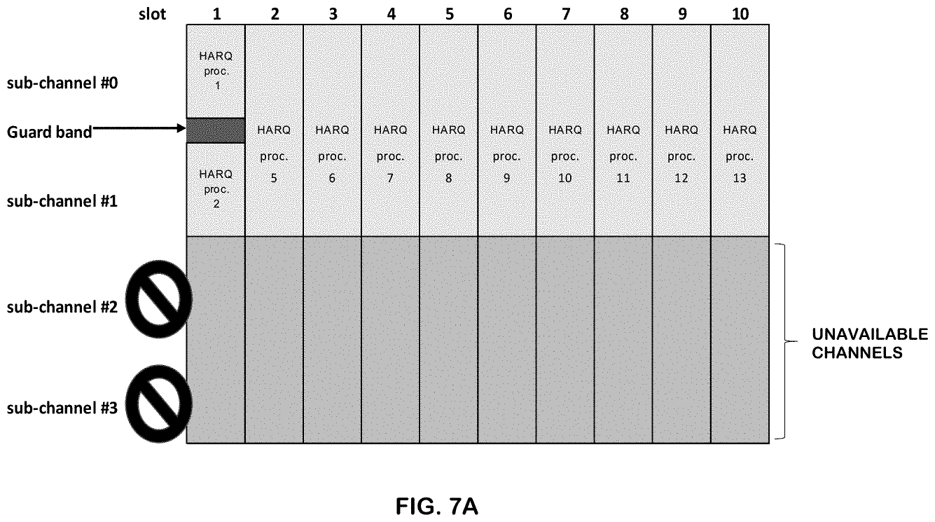

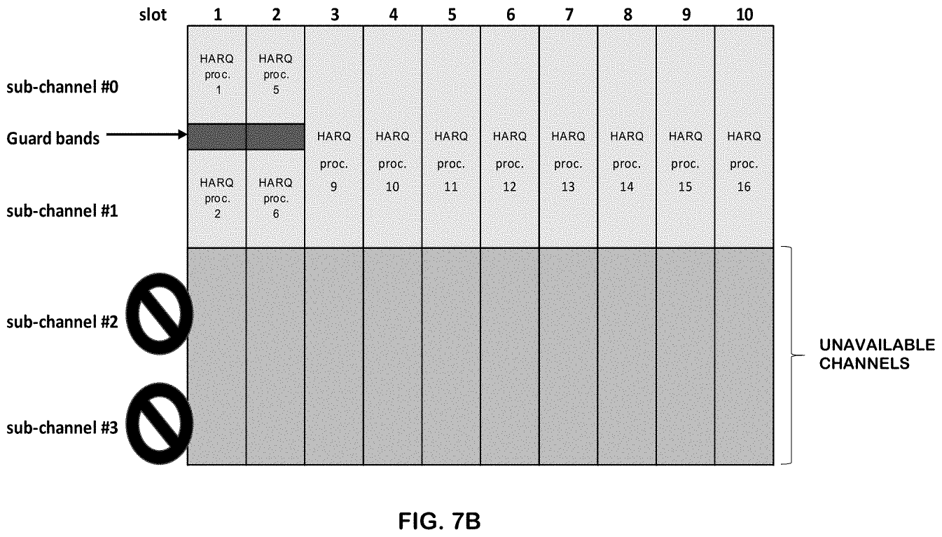

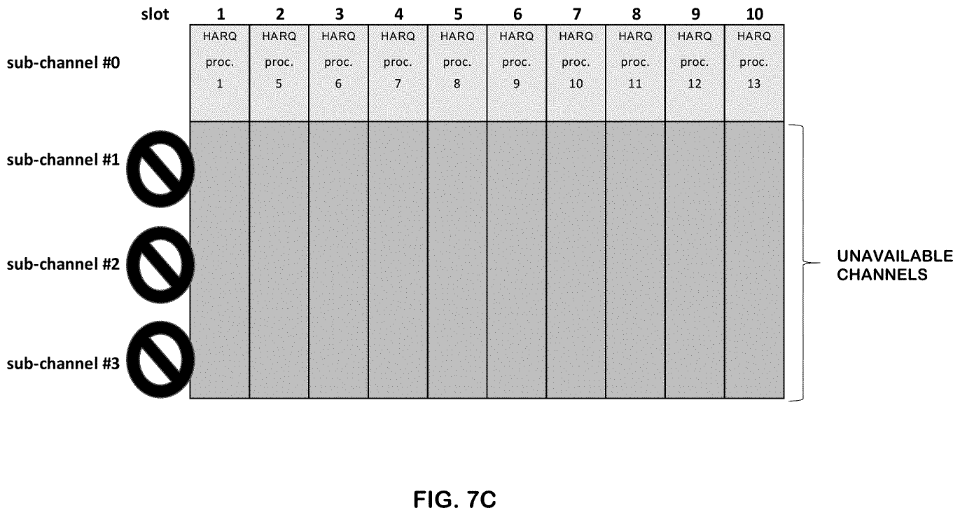

Referring now to FIGS. 7A-7C, these figures show further examples having ten slots (labeled 1-10) and four sub-channels (labeled sub-channel #0-#3) where some of the sub-channels are unavailable. In FIG. 7A, subchannels #2 and #3 are unavailable, and similar to FIG. 6, DCI indicates that HARQₛₜₐᵣₜ=1. In this example, the HARQ-IDs are calculated in a similar manner as described above with respect to FIG. 6 where X=4 sub-channels, n=1, and M=10. As sub-channels #2 and #3 are unavailable, the transport blocks of HARQ processes #3 and #4 are not transmitted and the transport block size determination of HARQ processes from #5 to #13 take the subchannel availability into account.

FIG. 7B illustrates an example where sub-channels #2 and #3 are unavailable and where X=4 sub-channels, n=2, and M=10. In this example, the transport blocks of HARQ processes #3, #4, #7, and #8 are not transmitted. In this example, the HARQ-IDs for slots 3-10, for example, are 9-16, respectively.

FIG. 7C illustrates an example where channels #1-#3 are unavailable, and where X=4 sub-channels, n=1, and M=10. In this example, a guard band is not added in slot 1 as only 1 sub-channel is available. As sub-channels #1-#3 are unavailable, the transport blocks of HARQ processes #2-#4 are not transmitted. It is also noted that the transport block sizes for slot 1 and slots 2-10 are equal. In this way, HARQ processes in the first slot/mini-slot may be transmitted based on the available channels and the determined TB/HARQ processes. In the remaining slots/mini-slots, the TBs/PUSCH data may be prepared based on the known channel availability (e.g. TBS defined based on the available number of RBs for transmission).

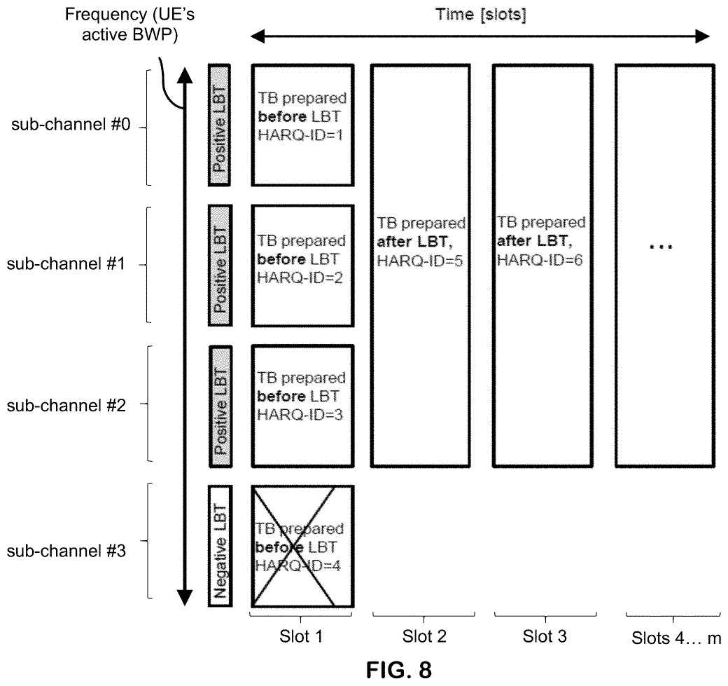

Referring now to FIG. 8, this figure illustrates an example of multi-slot scheduling in accordance with an example embodiment. FIG. 8 shows 4 sub-channels (i.e. sub-channels #0-#3) of an active NR BWP, each of which may be, for example, 20 MHz. In FIG. 4 there are M scheduled transmission time intervals (which in this example are slots with slot index m=1 . . . M). A gNB (e.g. RAN Node 170) schedules transmission on the four sub-channels. Prior to LBT, a UE prepares transmission for each of the sub-channels for slot 1. The UE performs LBT and determines that only three out of four channels are IDLE (i.e. sub-channels #0-#2). In other words, there is a positive LBT on sub-channels #0-#2 and a negative LTB on sub-channel #3. In the first slot after LBT (i.e. slot 1), the UE transmits 3 HARQ processes on the three IDLE sub-channels #0-2 where transmissions have been prepared. The prepared transmission with HARQ-ID=4 is dropped, as indicated by the ‘X’ over slot 1 of sub-channel #3 in FIG. 8. Immediately after LBT, UE starts to prepare transmission starting with HARQ-ID=5 for the remaining scheduled slots. As a result of LBT, TBs are prepared for the sub-channels #0-#2 and gaps in between.

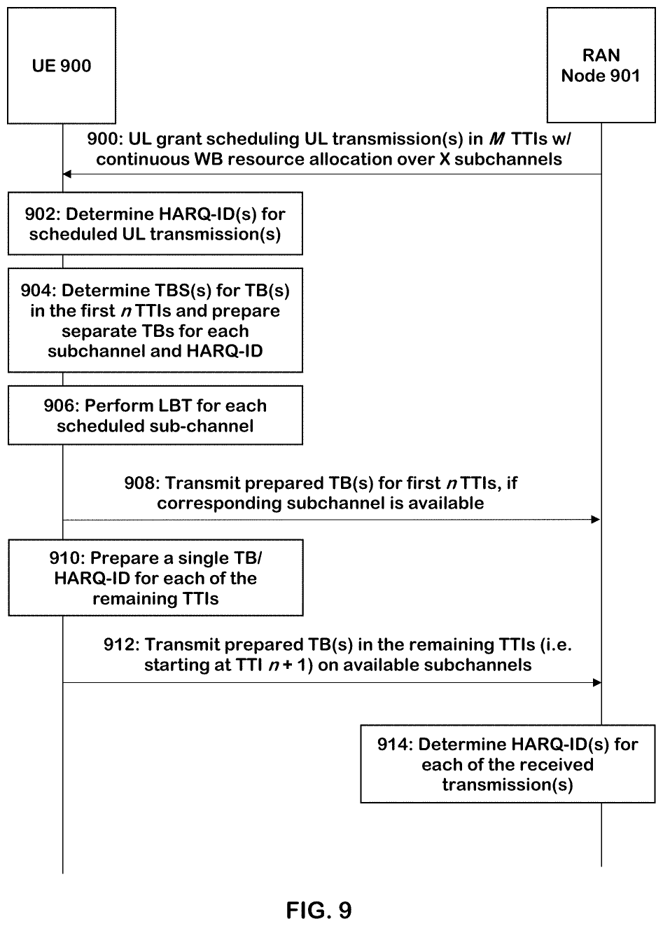

Referring now to FIG. 9, this figure shows a signaling diagram in accordance with an example embodiment. In this example the signaling is between UE 900 (such as UE 110 in FIG. 1 for example) and gNB 901 (such as RAN Node 170 in FIG. 1 for example). The gNB 901 transmits 902 a UL grant scheduling UL transmissions in M transmission time intervals with a continuous wideband resource allocation over X sub-channels. It is noted that the resource allocation indicated in the UL grant may cover the first and/or last sub-channel fully or only partially. The UE 900 determines 902 the HARQ-process ID(s) for the transmission(s) (e.g. PUSCH transmissions) scheduled in the UL grant from 900. The UE 900 then determines 904 the transport block size(s) for the transmit blocks in the n first transmission time intervals and prepares separate transport block(s) for each sub-channel and HARQ-ID. The UE 900 may then perform 906 LBT for each of the scheduled sub-channels. If, based on the LBT, at least one sub-channel is available then the UE transmits 908 the individually prepared transport blocks on the available sub-channels in the first n transmission time intervals after getting access to the channel according to determined HARQ-ID and TBS determination. For each of the remaining transmission time intervals, starting from transmission time interval n+1, the UE 900 prepares 910 transport block(s) of a single HARQ-process with corresponding HARQ-ID across the available sub-channels. It is noted that the UE may start preparations as soon as it knows which sub-channels have been acquired, and thus performance of block 910 could occur immediately after LBT 906. The preparing 910 includes determining the transport block sizes for the transport blocks in the remaining transmission time intervals and the respective HARQ-IDs. As noted above, the preparing also includes getting data from higher layers; TBS determination; channel coding and modulation; RE mapping; iFFT; digital filtering and/or RF retuning. The UE 900 then transmits the prepared transport block(s) in the remaining transmission time intervals starting from n+1 on the sub-channels that are available (i.e. those sub-channels were LBT was successful).

In one example embodiment, if none of the sub-channels are available based on the LBT performed in block 906, then the UE 900 returns to blocks 902 and 904 and prepares sub-channel specific TBs for another n next transmission time intervals.

In one example embodiment, the UE 900 leaves a predetermined number of empty PRBs or subcarriers between the scheduled sub-channels for the n first transmission time intervals.

In block 904, the UE may downscale the TBSs for first n transmission time intervals. For example, the UE 900 may divide the indicated TBS by the number of scheduled sub-channels X Alternatively, the UE 900 may determine the TBS for the first n transmission time intervals by masking allocated PRBs by PRBs of a given sub-channel.

In some examples, the UE 900 calculates TBS for the remaining transmission time intervals in block 910, where the TBS for the reaming transmission time intervals is upscaled, such as by multiplying by the number of sub-channels used for transmission for example. The TBS for the remaining transmission time intervals may be calculated in block 910 as: TBS=indicated_TBS*(number_of_accessed_sub-channels/number_of_scheduled_sub-channels). Alternatively, the transport block size for the remaining transmission time intervals (i.e. transmission time intervals starting at n+1) is determined by masking allocated PRBs by PRBs available for transmission (consisting of sub-channel with positive LBT and gaps in between).

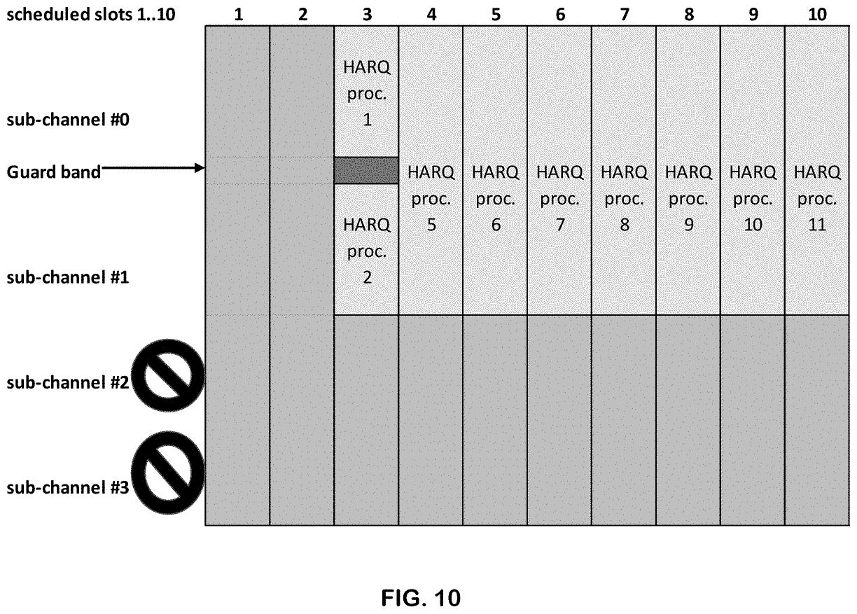

In one example embodiment, the UE is allowed to transmit M transmission time intervals in total independently of the transmission time interval it gets access to the channel. In other words, the UE will prepare the remaining transmission time intervals n+1 to M. In another example embodiment, the UE is not allowed to transmit outside the allocated multi-subframe resource allocation window. Depending on the time/slot the UE gets access to the channel via the LBT, the UE will only prepare the remaining transmission time intervals n+1 to M1, where M1 denotes the available transmission time intervals for transmission after the UE gains access to the channel till the end of the multi-subframe resource allocation. An example is shown in FIG. 10. In this example, the first two transmission time intervals (which are slots in this example) are not available and then sub-channels #0 and #1 are available starting from slot 3. Based on the negative LBT for the first two scheduled slots, only the remaining 8 slots can be used for data transmission, and thus the UE stops transmitting after slot 10.

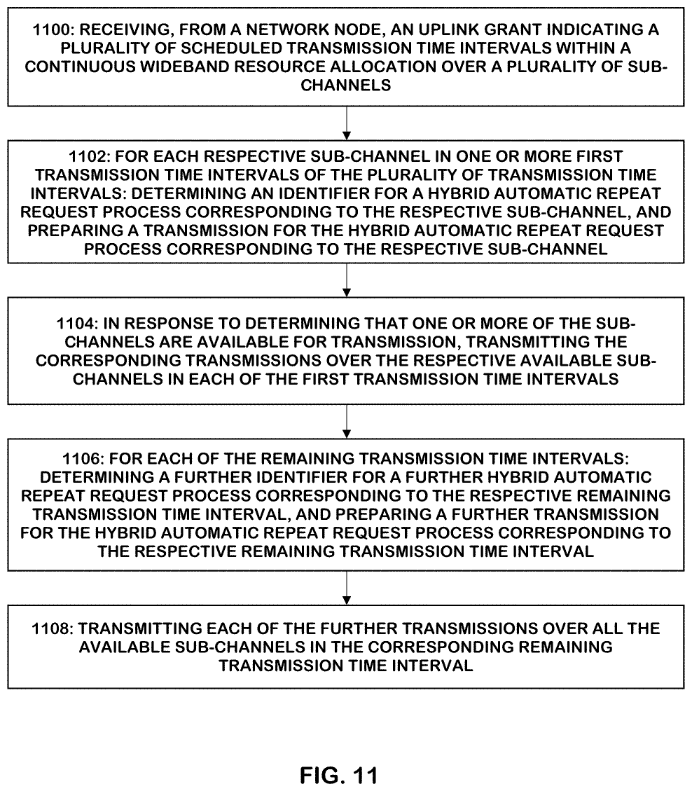

FIG. 11 is a logic flow diagram for uplink scheduling for NR-U. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the determination module 140-1 and/or 140-2 may include multiples ones of the blocks in FIG. 11, where each included block is an interconnected means for performing the function in the block. The blocks in FIG. 11 are assumed to be performed by the UE 110, e.g., under control of the determination module 140-1 and/or 140-2 at least in part.

According to an example of an embodiment (which may be referred to as example 1), a method is provided including: receiving, from a network node, an uplink grant indicating a plurality of scheduled transmission time intervals within a continuous wideband resource allocation over a plurality of sub-channels as indicated by block 1100; for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel as indicated by block 1102; in response to determining that one or more of the sub-channels are available for transmission, transmitting the corresponding transmissions over the respective available sub-channels in each of the first transmission time intervals as indicated by block 1104; for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval as indicated by block 1106; and transmitting each of the further transmissions over all the available sub-channels in the corresponding remaining transmission time interval as indicated by block 1108.

According to another example embodiment (which may be referred to as example 2), a method is provided as in example 1, wherein determining the one or more sub-channels are available comprises performing a listen before talk procedure on each of the plurality of sub-channels.

According to another example embodiment (which may be referred to as example 3), a method is provided as in any one of examples 1-2, wherein a number, n, of the one or more first transmission time intervals is at least one of: predefined; based on a processing time capability of the user equipment; and either indicated to the user equipment by the network node, or indicated by the user equipment to the network node.

According to another example embodiment (which may be referred to as example 4), a method is provided as in any one of examples 1-3, further comprising deriving, based on the uplink grant: a transport block size for one of the sub-channels; and at least one of: a transport block size for a total number of the available sub-channels; and a transport block size for a total number of available resources in the continuous wideband resource allocation.

According to another example embodiment (which may be referred to as example 5), a method is provided as in any one of examples 1-4, further comprising: leaving a specific number of empty physical resource blocks or sub-carriers between each of the plurality of sub-channels.

According to another example embodiment (which may be referred to as example 6), a method is provided as in any one of examples 1-5, wherein determining the identifiers for the hybrid automatic repeat request processes corresponding to each of the sub-channels in the one or more first transmission time intervals is based on the following: HARQ(m, x)=(HARQₛₜₐᵣₜ+(m−1)*X+x−1)mod HARQₘₐₓ, where: m=1 . . . n, where n is a total number of the one or more first transmission time intervals; x=1 . . . X, where X is a total number of the plurality of sub-channels; HARQₘₐₓ is a total number of hybrid automatic repeat request processes to be supported for the continuous wideband resource allocation; and HARQₛₜₐᵣₜ is a starting value for the identifiers.

According to another example embodiment (which may be referred to as example 7), a method is provided as in example 6, wherein determining the further identifiers for each of the remaining transmission time intervals is based on the following: HARQ(m)=(HARQₛₜₐᵣₜ+n*X+m−n−1)mod HARQₘₐₓ.

According to another example embodiment (which may be referred to as example 8), a method is provided as in any one of examples 1-7, wherein none of the plurality of sub-channels are initially available for transmission, and wherein the identifiers are determined starting from the transmission time interval in which at least one of the sub-channels becomes available for transmission.

According to another example embodiment (which may be referred to as example 9), a method is provided as in any one of examples 1-8, wherein the plurality of sub-channels comprises unlicensed frequency band channels.

According to another example embodiment (which may be referred to as example 10), a method is provided as in any one of examples 1-9, wherein the plurality of transmission time intervals comprises at least one of: one or more slots; and one or more mini-slots.

According to another example embodiment (which may be referred to as example 11), an apparatus is provided comprising means for receiving, from a network node, an uplink grant indicating a plurality of scheduled transmission time intervals within a continuous wideband resource allocation over a plurality of sub-channels; for each respective sub-channel in one or more first transmission time intervals of the plurality of transmission time intervals: means for determining an identifier for a hybrid automatic repeat request process corresponding to the respective sub-channel, and means for preparing a transmission for the hybrid automatic repeat request process corresponding to the respective sub-channel; in response to determining that one or more of the sub-channels are available for transmission, means for transmitting the corresponding transmissions over the respective available sub-channels in each of the first transmission time intervals; for each of the remaining transmission time intervals: means for determining a further identifier for a further hybrid automatic repeat request process corresponding to the respective remaining transmission time interval, and means for preparing a further transmission for the hybrid automatic repeat request process corresponding to the respective remaining transmission time interval; and means for transmitting each of the further transmissions over all the available sub-channels in the corresponding remaining transmission time interval.

According to another example embodiment (which may be referred to as example 12), an apparatus is provided as in example 11, the apparatus further comprising means for performing a method as in any one of examples 2-10.

According to another example embodiment (which may be referred to as example 13), a computer readable medium is provided comprising program instructions for causing an apparatus to perform at least the following: receiving, from a network node, an uplink grant indicating a plurality of scheduled transmission time intervals within a continuous wideband resource allocation over a plurality of sub-channels; for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel; in response to determining that one or more of the sub-channels are available for transmission, transmitting the corresponding transmissions over the respective available sub-channels in each of the first transmission time intervals; for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and transmitting each of the further transmissions over all the available sub-channels in the corresponding remaining transmission time interval.

According to another example embodiment (which may be referred to as example 14), a computer readable medium is provided as in example 13, wherein the program instructions further cause the apparatus to perform a method as in any one of examples 2-10.

According to another example embodiment (which may be referred to as example 15), an apparatus is provided including at least one processor; and at least one memory including computer program code, the at least one non-transitory memory and the computer program code configured to, with the at least one processor, cause the apparatus to perform at least: receiving, from a network node, an uplink grant indicating a plurality of scheduled transmission time intervals within a continuous wideband resource allocation over a plurality of sub-channels; for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel; in response to determining that one or more of the sub-channels are available for transmission, transmitting the corresponding transmissions over the respective available sub-channels in each of the first transmission time intervals; for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and transmitting each of the further transmissions over all the available sub-channels in the corresponding remaining transmission time interval.

According to another example embodiment (which may be referred to as example 16), an apparatus is provided as in example 15, wherein the apparatus is further caused to perform a method as in any one of examples 2-10.

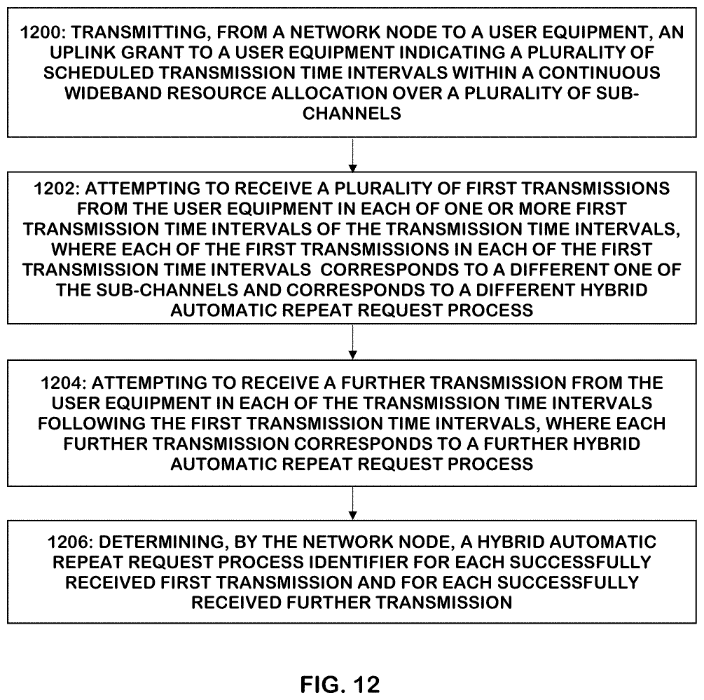

FIG. 12 is a logic flow diagram for uplink scheduling for NR-U. This figure further illustrates the operation of an exemplary method or methods, a result of execution of computer program instructions embodied on a computer readable memory, functions performed by logic implemented in hardware, and/or interconnected means for performing functions in accordance with exemplary embodiments. For instance, the scheduling module 150-1 and/or 150-2 may include multiples ones of the blocks in FIG. 12, where each included block is an interconnected means for performing the function in the block. The blocks in FIG. 12 are assumed to be performed by a base station such as RAN node 170, e.g., under control of the scheduling module 150-1 and/or 150-2 at least in part.

According to an example of an embodiment (which may be referred to as example 17), a method is provided including: transmitting, from a network node to a user equipment, an uplink grant to a user equipment indicating a plurality of scheduled transmission time intervals within a continuous wideband resource allocation over a plurality of sub-channels as indicated by block 1200; attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process as indicated by block 1202; attempting to receive a further transmission from the user equipment in each of the transmission time intervals following the first transmission time intervals, where each further transmission corresponds to a further hybrid automatic repeat request process as indicated by block 1204; and determining, by the network node, a hybrid automatic repeat request process identifier for each successfully received first transmission and for each successfully received further transmission as indicated by block 1206.

According to another example embodiment (which may be referred to as example 18), a method is provided as in example 17, wherein a number, n, of the one or more first transmission time intervals is at least one of: predefined; based on a processing time capability of the user equipment; and either indicated to the user equipment by the network node, or indicated by the user equipment to the network node.

According to another example embodiment (which may be referred to as example 19), a method is provided as in any one of examples 17-18, the method further comprising: deriving, at least partially based on the successfully received first transmissions, a transport block size corresponding to each of the remaining transmission time intervals.

According to another example embodiment (which may be referred to as example 20), a method is provided as in any one of examples 17-19, wherein a number of empty physical resource blocks or sub-carriers are between each of the plurality of sub-channels.

According to another example embodiment (which may be referred to as example 21), a method is provided as in any one of examples 17-20, wherein determining the hybrid automatic repeat request process identifier for each successfully received first transmission is based on the following function: HARQ(m, x)=(HARQₛₜₐᵣₜ+(m−1)*X+x−1)mod HARQₘₐₓ, where: m=1 . . . n, where n is a total number of the one or more first transmission time intervals; x=1 . . . X, where X is a total number of the plurality of sub-channels; HARQₘₐₓ is a total number of hybrid automatic repeat request processes that is to be supported for the continuous wideband resource allocation; and HARQₛₜₐᵣₜ is a starting value for the hybrid automatic repeat request process identifiers.

According to another example embodiment (which may be referred to as example 22), a method is provided as in example 21, wherein determining the hybrid automatic repeat request process identifier for each successfully received further transmission is based on the following function: HARQ(m)=(HARQₛₜₐᵣₜ+n*X+m−n−1)mod HARQₘₐₓ.

According to another example embodiment (which may be referred to as example 23), a method is provided as in any one of examples 17-22, wherein each successfully received first transmission is received following one or more initial transmission time intervals of the scheduled transmission time intervals, and wherein the hybrid automatic repeat request process identifier for each successfully received first transmission is determined starting from the earliest scheduled transmission time interval in which at least one of the first transmissions is successfully received.

According to another example embodiment (which may be referred to as example 24), a method is provided as in any one of examples 17-23, wherein the plurality of sub-channels comprises unlicensed frequency band channels.

According to another example embodiment (which may be referred to as example 25), a method is provided as in any one of examples 17-24, wherein the plurality of transmission time intervals comprises at least one of: one or more slots; and one or more mini-slots.

According to another example embodiment (which may be referred to as example 26), an apparatus is provided comprising means for transmitting, from a network node to a user equipment, an uplink grant to a user equipment indicating a plurality of scheduled transmission time intervals within a continuous wideband resource allocation over a plurality of sub-channels; means for attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; means for attempting to receive a further transmission from the user equipment in each of the transmission time intervals following the first transmission time intervals, where each further transmission corresponds to a further hybrid automatic repeat request process; and means for determining, by the network node, a hybrid automatic repeat request process identifier for each successfully received first transmission and for each successfully received further transmission.

According to another example embodiment (which may be referred to as example 27), an apparatus is provided as in example 26, the apparatus further comprising means for performing a method as in any one of examples 18-25.

According to another example embodiment (which may be referred to as example 28), a computer readable medium is provided comprising program instructions for causing an apparatus to perform at least the following: transmitting, from a network node to a user equipment, an uplink grant to a user equipment indicating a plurality of scheduled transmission time intervals within a continuous wideband resource allocation over a plurality of sub-channels; attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; attempting to receive a further transmission from the user equipment in each of the transmission time intervals following the first transmission time intervals, where each further transmission corresponds to a further hybrid automatic repeat request process; and determining, by the network node, a hybrid automatic repeat request process identifier for each successfully received first transmission and for each successfully received further transmission.

According to another example embodiment (which may be referred to as example 29), a computer readable medium is provided as in example 28, wherein the program instructions further cause the apparatus to perform a method as in any one of examples 18-25.

According to another example embodiment (which may be referred to as example 30), an apparatus is provided including at least one processor; and at least one memory including computer program code, the at least one non-transitory memory and the computer program code configured to, with the at least one processor, cause the apparatus to perform at least the following: transmitting, from a network node to a user equipment, an uplink grant to a user equipment indicating a plurality of scheduled transmission time intervals within a continuous wideband resource allocation over a plurality of sub-channels; attempting to receive a plurality of first transmissions from the user equipment in each of one or more first transmission time intervals of the transmission time intervals, where each of the first transmissions in each of the first transmission time intervals corresponds to a different one of the sub-channels and corresponds to a different hybrid automatic repeat request process; attempting to receive a further transmission from the user equipment in each of the transmission time intervals following the first transmission time intervals, where each further transmission corresponds to a further hybrid automatic repeat request process; and determining, by the network node, a hybrid automatic repeat request process identifier for each successfully received first transmission and for each successfully received further transmission.

According to another example embodiment (which may be referred to as example 31), an apparatus is provided as in example 30, wherein the apparatus is further caused to perform a method as in any one of examples 18-25.

Without in any way limiting the scope, interpretation, or application of the claims appearing below, a technical effect of one or more of the example embodiments disclosed herein is enabling flexible bandwidth adaptation with a single multi-slot UL grant. Another technical effect of one or more of the example embodiments disclosed herein is reducing the number of HARQ processes scheduled, which reduces data fragmentation and reduces scheduling DCI size as less NDI bits are needed. Another technical effect of one or more of the example embodiments disclosed herein is defines rules for adapting TBS depending on the number of accessed sub-channels.

Embodiments herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain, store, and/or transport the instructions for use by or in connection with an instruction execution system, apparatus, or device, such as a computer. A computer-readable storage medium does not comprise propagating signals.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
receiving, from a network node, an uplink grant indicating a plurality of scheduled transmission time intervals within a continuous wideband resource allocation over a plurality of sub-channels;
for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel;
in response to determining that one or more of the sub-channels are available for transmission, transmitting the corresponding transmissions over the respective available sub-channels in each of the first transmission time intervals;
for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and
transmitting each of the further transmissions over all the available sub-channels in the corresponding remaining transmission time interval.

2. The method as in claim 1, wherein determining the one or more sub-channels are available comprises performing a listen before talk procedure on each of the plurality of sub-channels.

3. The method as in claim 1, wherein a number, n, of the one or more first transmission time intervals is at least one of:
predefined;
based on a processing time capability of the user equipment; and
either indicated to the user equipment by the network node, or indicated by the user equipment to the network node.

4. The method as in claim 1, further comprising deriving, based on the uplink grant:
a transport block size for one of the sub-channels; and
at least one of:
a transport block size for a total number of the available sub-channels; and
a transport block size for a total number of available resources in the continuous wideband resource allocation.

5. The method as in claim 1, further comprising:
leaving a specific number of empty physical resource blocks or sub-carriers between each of the plurality of sub-channels.

6. The method as in claim 1, wherein determining the identifiers for the hybrid automatic repeat request processes corresponding to each of the sub-channels in the one or more first transmission time intervals is based on the following:
HARQ(m,x)=(HARQₛₜₐᵣₜ+(m−1)*X+x−1)mod HARQₘₐₓ, where:
m=1 . . . n, where n is a total number of the one or more first transmission time intervals;
x=1 . . . X, where X is a total number of the plurality of sub-channels;
HARQₘₐₓ is a total number of hybrid automatic repeat request processes to be supported for the continuous wideband resource allocation; and
HARQₛₜₐᵣₜ is a starting value for the identifiers.

7. The method as in claim 6, wherein determining the further identifiers for each of the remaining transmission time intervals is based on the following: HARQ(m)=(HARQₛₜₐᵣₜ+n*X+m−n−1)mod HARQₘₐₓ.

8. The method as in claim 1, wherein none of the plurality of sub-channels are initially available for transmission, and wherein the identifiers are determined starting from the transmission time interval in which at least one of the sub-channels becomes available for transmission.

9. The method as in claim 1, wherein the plurality of sub-channels comprises unlicensed frequency band channels.

10. The method as in claim 1, wherein the plurality of transmission time intervals comprises at least one of:
one or more slots; and
one or more mini-slots.

11-40. (canceled)

41. An apparatus comprising:
at least one processor; and
at least one non-transitory memory including computer program code, the at least one memory and the computer program code configured to, with the at least one processor, cause the apparatus to perform operations comprising:
receiving, from a network node, an uplink grant indicating a plurality of scheduled transmission time intervals within a continuous wideband resource allocation over a plurality of sub-channels;
for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel;
in response to determining that one or more of the sub-channels are available for transmission, transmitting the corresponding transmissions over the respective available sub-channels in each of the first transmission time intervals;
for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and
transmitting each of the further transmissions over all the available sub-channels in the corresponding remaining transmission time interval.

42. The apparatus as in claim 41, wherein determining the one or more sub-channels are available comprises performing a listen before talk procedure on each of the plurality of sub-channels.

43. The apparatus as in any one of claim 41, wherein a number, n, of the one or more first transmission time intervals is at least one of:
predefined;
based on a processing time capability of the user equipment; and
either indicated to the user equipment by the network node, or indicated by the user equipment to the network node.

44. The apparatus as in claim 41, wherein the at least one memory and the computer program code are further configured, with the at least one processor, to cause the apparatus to perform additional operations comprising:
deriving, based on the uplink grant:
a transport block size for one of the sub-channels; and
at least one of:
a transport block size for a total number of the available sub-channels; and
a transport block size for a total number of available resources in the continuous wideband resource allocation.

45. The apparatus as in claim 41, wherein the at least one memory and the computer program code are further configured, with the at least one processor, to cause the apparatus to perform additional operations comprising:
leaving a specific number of empty physical resource blocks or sub-carriers between each of the plurality of sub-channels.

46. The apparatus as in 41, wherein determining the identifiers for the hybrid automatic repeat request processes corresponding to each of the sub-channels in the one or more first transmission time intervals is based on the following:
HARQ(m,x)=(HARQₛₜₐᵣₜ+(m−1)*X+x−1)mod HARQₘₐₓ, where:
m=1 . . . n, where n is a total number of the one or more first transmission time intervals;
x=1 . . . X, where X is a total number of the plurality of sub-channels;
HARQₘₐₓ is a total number of hybrid automatic repeat request processes to be supported for the continuous wideband resource allocation; and
HARQₛₜₐᵣₜ is a starting value for the identifiers.

47. The apparatus as in claim 46, wherein determining the further identifiers for each of the remaining transmission time intervals is based on the following: HARQ(m)=(HARQₛₜₐᵣₜ+n*X+m−n−1)mod HARQₘₐₓ.

48. The apparatus as in claim 41, wherein none of the plurality of sub-channels are initially available for transmission, and wherein the identifiers are determined starting from the transmission time interval in which at least one of the sub-channels becomes available for transmission.

49. The apparatus as in claim 41, wherein the plurality of sub-channels comprises unlicensed frequency band channels.

50. A non-transitory computer readable medium comprising program instructions for causing an apparatus to perform at least the following:
receiving, from a network node, an uplink grant indicating a plurality of scheduled transmission time intervals within a continuous wideband resource allocation over a plurality of sub-channels;
for each respective sub-channel in one or more first transmission time intervals of the plurality of transmission time intervals: determining an identifier for a hybrid automatic repeat request process corresponding to the respective sub-channel, and preparing a transmission for the hybrid automatic repeat request process corresponding to the respective sub-channel;
in response to determining that one or more of the sub-channels are available for transmission, transmitting the corresponding transmissions over the respective available sub-channels in each of the first transmission time intervals;
for each of the remaining transmission time intervals: determining a further identifier for a further hybrid automatic repeat request process corresponding to the respective remaining transmission time interval, and preparing a further transmission for the hybrid automatic repeat request process corresponding to the respective remaining transmission time interval; and
transmitting each of the further transmissions over all the available sub-channels in the corresponding remaining transmission time interval.
